(19) United States
(12) Patent Application Publication
(10) Pub. No.: US 2013/0179829 A1
(43) Pub. Date: Jul. 11, 2013

(54) METHOD AND APPARATUS FOR DISPLAYING AND SCROLLING ITEMS

(71) Applicant: SAMSUNG ELECTRONICS CO., LTD., Gyeonggi-do (KR)

(72) Inventors: Eun-Suk KWON, Gyeongsangbuk-do (KR); Gun-Su LEE, Gyeongsangbuk-do (KR); Bum-Soo KIM, Daegu (KR)

(73) Assignee: SAMSUNG ELECTRONICS CO., LTD., Gyeonggi-do (KR)

(21) Appl. No.: 13/736,256

(22) Filed: Jan. 8, 2013

(30) Foreign Application Priority Data
Jan. 9, 2012 (KR) 10-2012-0002518

(51) Int. Cl. G06F 3/0485

(52) U.S. Cl. CPC G06F 3/0485
USPC 715/784

(57) ABSTRACT

A method and apparatus for facilitating scrolling of items on a display screen of an electronic device are provided. A first number of scrollable items representing a portion of a set of displayable items are displayed on the display screen. An input command for performing an “easy scroll function” is then detected. In response to the detected input command, the display screen is divided into a predetermined number of divided display screens, each independently scrollable and each displaying a respective number of items of the set of items, according to a display setting therefor. Each divided display screen may display a different number of items and may be scrollable at a different rate.

### CLAIM OF PRIORITY

This application claims priority under 35 U.S.C. §119(a) to a Korean Patent Application entitled “Method and Apparatus for Scroll-Displaying Items” filed in the Korean Intellectual Property Office on Jan. 9, 2012 and assigned Serial No. 10-2012-0002518, the contents of which are incorporated herein by reference.

### BACKGROUND

1. Technical Field

This disclosure relates to controlling scroll operations on a display of an electronic device, and more particularly, to facilitating scrolling of items on a device having a touch screen display.

2. Description of the Related Art

With recent advances in portable electronic devices, a myriad of functions are provided for which large numbers of scrollable items are displayed on the device screen. For example, a portable terminal such as a smart phone provides various functions of a multimedia player, an e-book reader, a text editor, etc.

These various functions allow for the scrollable display of contents stored in the electronic device or stored externally in a cloud system or the like and transmitted to the device. The various functions display contents such as a moving image clip, a music file, a document file, or the like, which are provided by streaming using wired/wireless communication.

Accordingly, when the electronic device is in use, the user can first request the display of a list of contents, and can then request the use (e.g. reproduction) of a selected content, by selecting the desired content from among the displayed contents. For example, when the user intends to use a function for reproducing music, the user can first cause a list of contents, such as mp3 files, to be displayed, and can then select an mp3 file intended to be reproduced.

However, an electronic device, such as a portable terminal with a touch screen, has a limit in that contents matched with functions desired to be used cannot all be displayed on one display screen, due to the small size of the display screen. For example, if a list contains 100 selectable items, all 100 items cannot be practically displayed on one display screen at once. To view any desired item, a scroll function is operated in which items are scrollable in response to a user's touch gesture on the touch screen, e.g., a sweep contact on the screen surface. That is, currently displayed items are replaced with subsequent or prior items of the list in response to the touch gesture.

Problems of prior art scrolling will be described below with reference to FIG. 1 which is an illustrative view showing a conventional scroll display function. Hereinafter, in describing the prior art as well as exemplary embodiments of the present invention, scrollable contents will be referred to as items. Further, as used herein, items said to be “scroll-displayed” during a scroll operation signifies that the items are displayed moving across the screen responsive to a scroll command.

For instance, in a case where the number of items to be displayed on a touch screen is 100 as shown in list (a) of FIG. 1, when a user requests display of the list (for example, 100 mp3 files), only a small portion (7 of 100) of the items in the list are displayed according to a display setting as shown in screen (b). In a state as shown in (b) of FIG. 1, the user can request scroll display through a touch gesture 10 in order to identify items of the list after item 7. Screen (c) depicts items displayed (4 through 10) on the screen following a short scroll gesture in the up direction.

However, when the user intends to identify items from item 93 to item 99, as shown in screen (d), there is a problem in that the user must repeatedly enter a scroll input as denoted by reference numeral 10 in screen (b).

Namely, in the case of the prior art, the display screen is set in such a manner as to display a relatively small predetermined number (e.g. 7) of items, where the number is set practically according to the size of text or objects readily discernible by the typical user. Accordingly, in order to display an item, such as item 99, which is located rearward in display order among the 100 items, there is a limit in that multiple scroll inputs and a lot of time are required.

In a prior art approach to solve the above problem, there is a technology for scrolling items at a high speed when a displayable list contains a large number of items. However, with high speed scrolling, a user is inconvenienced by being unable to properly identify items during the course of the high speed scroll, and cannot select desired items at a proper time.

Accordingly, a need exists for a user friendly interface to address the above-described scroll-related problems. Particularly, as high-speed mobile communication functions in advanced protocols such as Long Term Evolution (LTE) are popularized and storage space of a portable terminal increases, the number of items that can be used in portable electronic devices will gradually increase. Thus the need for a user-friendly means of scrolling through large lists on small screens is apparent.

### SUMMARY

Exemplary embodiments of a method and apparatus for facilitating scrolling of items on a display screen of an electronic device are disclosed. A first number of scrollable items representing a portion of a set of displayable items are displayed on the display screen. An input command for performing an “easy scroll function” is then detected. In response to the detected input command, the display screen is divided into a predetermined number of divided display screens, each independently scrollable. Each divided display screen displays a respective number of items of the set of items, according to a display setting therefor.

Each divided display screen may display a different number of items and may be scrollable at a different rate.

When items are arranged to be scrollable vertically, the input command for the easy scroll function may be a scroll input (e.g., sweeping touch contact in vertical direction) applied to a left side portion of the display screen. However, a scroll input entered on the right side of the screen can be recognized as a normal scroll input to scroll the currently displayed items.

The predetermined number of divided display screens may be re-divided into a higher number of divided display screens upon detecting an additional input command for an easy scroll function applied to any one of the divided display screens.

One or more embodiments of the invention provide the following advantages: A particular item in a set of a large number of items can be identified, or identified and selected, using a reduced number of scroll gestures and a reduced amount of time as compared to conventional techniques. An easy discrimination can be made between items that are being scrolled, and a desired item can then be easily selected from among the distinguished items. Thus an improved user interface for scrolling items is provided, which is particularly advantageous for electronic devices having small touch screens.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is an illustrative view showing a conventional scroll display function;

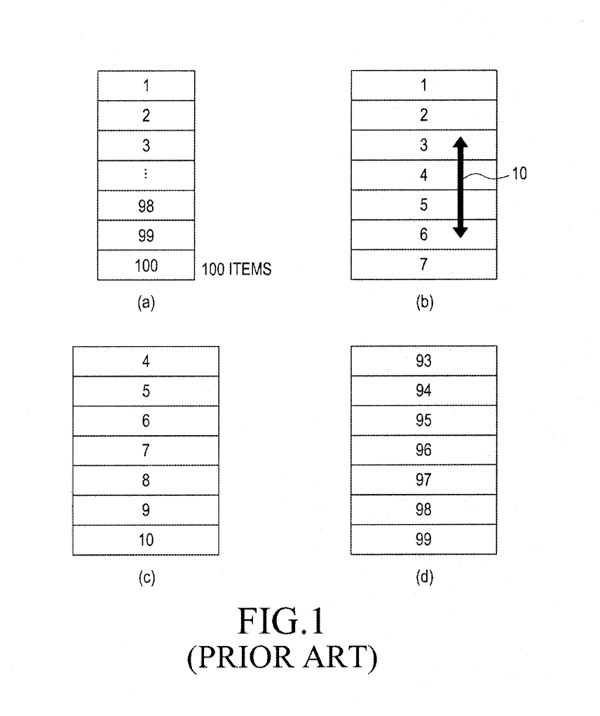

FIG. 2 is a functional block diagram of a portable terminal according to an exemplary embodiment of the present invention;

FIG. 3 is a flowchart showing a process for performing an easy scroll function according to an exemplary embodiment of the present invention;

FIG. 4 is a first illustrative view showing a process for performing an easy scroll function according to an exemplary embodiment of the present invention;

FIG. 5 is a second illustrative view showing a process for performing an easy scroll function according to an exemplary embodiment of the present invention; and

FIG. 6 is a third illustrative view showing a process for performing an easy scroll function according to an exemplary embodiment of the present invention.

### DETAILED DESCRIPTION OF EXEMPLARY EMBODIMENTS

Below, exemplary embodiments will be described in detail with reference to accompanying drawings so as to be easily realized by a person having ordinary skill in the art. The invention may be embodied in various forms and is not limited to the embodiments set forth herein. Descriptions of well-known parts are omitted for clarity, and like reference numerals refer to like elements throughout.

In the following description of exemplary embodiments of the present invention, the term “item” refers to a displayable object which can be scrolled by suitable commands of an electronic apparatus. Types of items are vast; examples include menu items, text messages, phone book contacts, photographs, thumbnails, objects representing document files, icons, text lines in web pages, and so forth. The term “scrolling” is used herein in the conventional sense, i.e., to move items up, down, or across a display screen, with new items appearing on the screen as old items disappear. Phrases such as “the display screen is scrolled” or “items are scrolled” are used interchangeably to refer to the same operation of scrolling taking place on the display screen. The term “scroll-displayed” is sometimes used herein to signify that during a scroll operation, items being scrolled are displayed moving across the screen in the scroll direction.

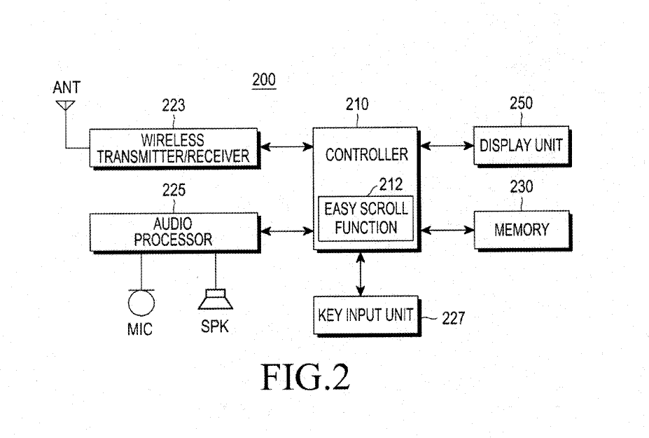

FIG. 2 is a functional block diagram of a portable terminal, 200, according to an exemplary embodiment of the present invention. Portable terminal 200 is a generally small electronic device that can be hand carried, and can be any one of a variety of electronic devices capable of scrolling items on a display thereof. Examples include a smart phone, a video phone, a feature phone, an IMT-2000 (International Mobile Telecommunication 2000) terminal, a WCDMA (Wideband Code Division Multiple Access) terminal, a UMTS (Universal Mobile Telecommunication Service) terminal, a Long Term Evolution (LTE) compatible terminal, a PDA (Personal Digital Assistant), a PMP (Portable Multimedia Player), a DMB (Digital Multimedia Broadcasting) terminal, an e-book terminal, portable computers (e.g. a laptop, a tablet PC, etc.), a digital camera, music player, etc.

Portable terminal 200 has a wireless transmitter/receiver 223 including an RF (Radio Frequency) unit and a modem (modulator/demodulator). The RF unit includes an RF transmitter for upconverting the frequency of a signal to be transmitted and then amplifying the frequency-upconverted signal, an RF receiver for low-noise amplifying a received signal and then downconverting the frequency of the low-noise amplified signal, etc. The modem includes a transmitter for encoding and modulating a signal to be transmitted, a receiver for demodulating and decoding a signal received by the RF unit, etc.

An audio processor 225 may include a codec (coder/decoder), and the codec may include a data codec and an audio codec. The data codec processes packet data, etc., and the audio codec processes audio signals including voice, a multimedia file, etc. The audio processor 225 converts a digital audio signal, which has been received by the modem, to an analog signal through the audio codec, and then reproduces the analog signal. Also, the audio processor 225 converts an analog audio signal, which is generated from a microphone, to a digital audio signal through the audio codec, and then transmits the digital audio signal to the modem. The codec may be separately provided, or may be included in a controller 210 of the portable terminal.

A key input unit 227 may include keys for inputting numbers and text information and function keys for setting various functions, and may be in the form of a touchpad or the like. When a display unit 250 employs a capacitive/electrostatic touch screen, a resistive/pressure-sensitive touch screen or the like, the key input unit 227 may include only a minimum number of keys, which have previously been set. In this case, the display unit 250 may partially perform a key input function of the key input unit 227, in place of the key input unit 227.

A memory 230 may include a program memory and a data memory, and the program memory stores programs for controlling a general operation of the portable terminal. The memory 230 may further include external memories, including a CF (Compact Flash) memory card, an SD (Secure Digital) memory card, a Micro-SD (Micro Secure Digital) memory card, a Mini-SD (Mini Secure Digital) memory card, an XD (Extreme Digital) memory card, a memory stick, etc. Also, the memory 230 may include disks, including an HDD (Hard Disk Drive), an SSD (Solid State Disk), etc.

The display unit 250 may be implemented by an LCD (Liquid Crystal Display), and/or an OLED (Organic Light-Emitting Diode, such as either a PMOLED (Passive Matrix Organic LED) or an AMOLED (Active Matrix Organic LED)), and outputs various pieces of display information provided by the portable terminal. The display unit 250 preferably includes a touch screen, e.g., a capacitive/electrostatic or a resistive/pressure-sensitive type touch screen, and then may serve as an input unit for controlling the portable terminal, together with the key input unit 227.

A user may enter a scroll input through the display unit 250 which makes a request for scrolling items currently displayed, through performing of the scroll input. For instance, a scroll input is preferably recognized when a sweeping touch gesture on a touch screen of the display unit 250 is recognized in a direction in which scrolling can be implemented. For items displayed in a vertical oriented list, scrolling direction is vertical. Items can also be displayed in a horizontal row and scrolled horizontally.

Meanwhile, a scroll input may also be entered through the key input unit 227. However, as will be described further below, an exemplary embodiment of the present invention “partitions” a display screen or a divided display screen into a left part and a right part. When partitioned, functions to be carried out are distinguished based on whether a touch gesture is detected at the left or right parts of the display screen. For instance, a conventional scroll function or an easy scroll function are implemented according to an exemplary embodiment of the present invention, according to whether a scroll input is entered in the left part or in the right part. Accordingly, in an exemplary embodiment of the present invention, it is assumed that a scroll input is entered through a touch screen of the display unit 250.

The controller 210 controls an overall operation of the portable terminal 200, and may change and control the operation of the portable terminal by a user's input provided by either the key input unit 227, the display unit 250, or the like. The display unit 250 is controllable by the controller 250 to display on its display screen a first number of scrollable items representing a portion of a set of displayable items. The controller 210 according to an exemplary embodiment of the present invention is configured with an “easy scroll function” control element 212, enabling the controller to detect an input command for performing an easy scroll function on the display screen. Responsive to the detected input command, controller 210 controls dividing of the display screen into a predetermined number of divided display screens. Each divided display screen is independently scrollable and each displays a respective number of items of the set of items, according to a display setting for that divided display screen. The easy scroll function control element 212 may be implemented in hardware, software, or a combination thereof. For instance, a program to carry out the easy scroll function operations may be stored as program code in memory 230 and executed by a processor within controller 210. A detailed operation of the controller 210 according to an exemplary embodiment of the present invention will be explained through the following description.

Meanwhile, although devices such as a Bluetooth module, a camera module, a WiFi module, an acceleration sensor, a proximity sensor, a Geo-magnetic sensor, a DMB (Digital Multimedia Broadcasting) receiver, etc., which may be included in a portable terminal, are not shown in the block diagram of FIG. 2, it will be apparent to those skilled in the art that these devices, which are not shown in FIG. 2, may be included in a portable terminal according to an exemplary embodiment of the present invention in order to provide the relevant functions of these devices.

For example, an acceleration sensor may be used to sense a display direction of the display unit of the portable terminal, and may be used to display items, which are being displayed in a display direction, in a landscape mode or in a portrait mode.

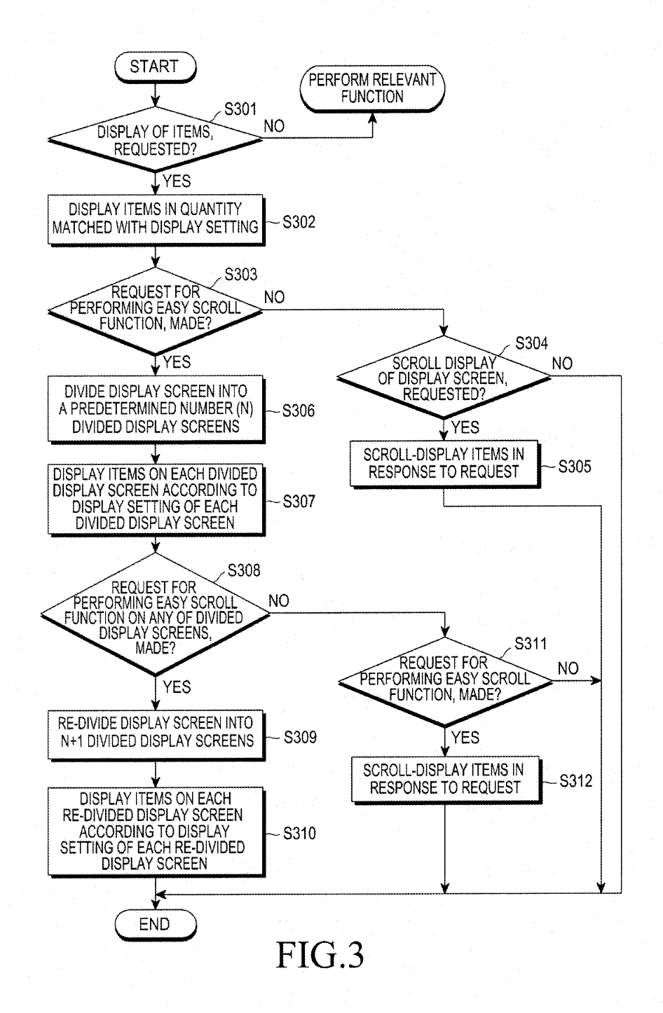

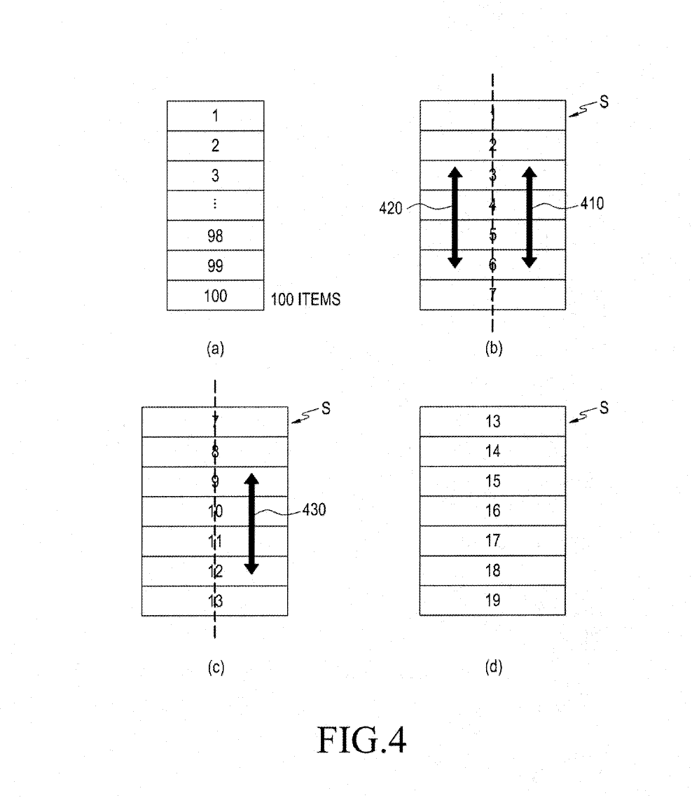

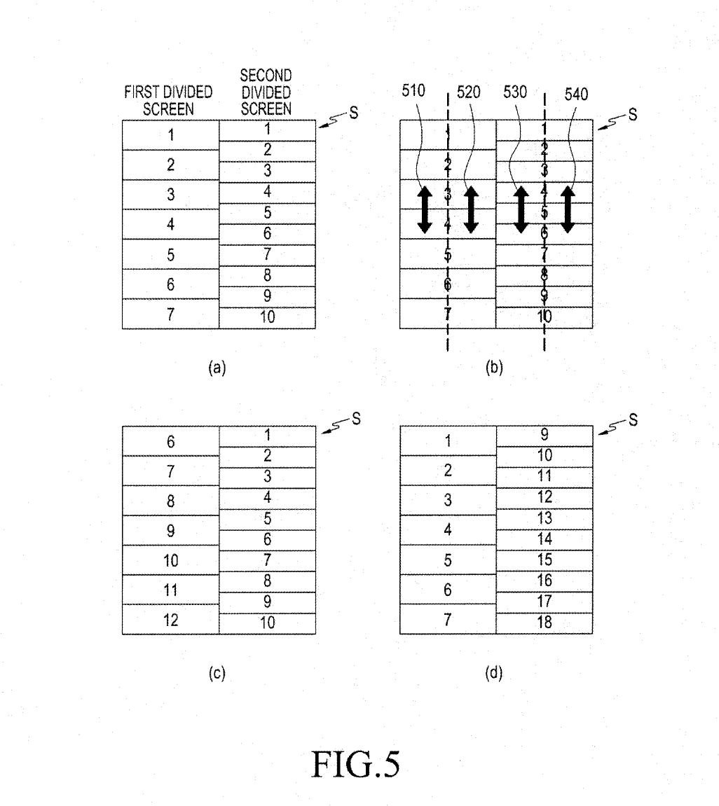

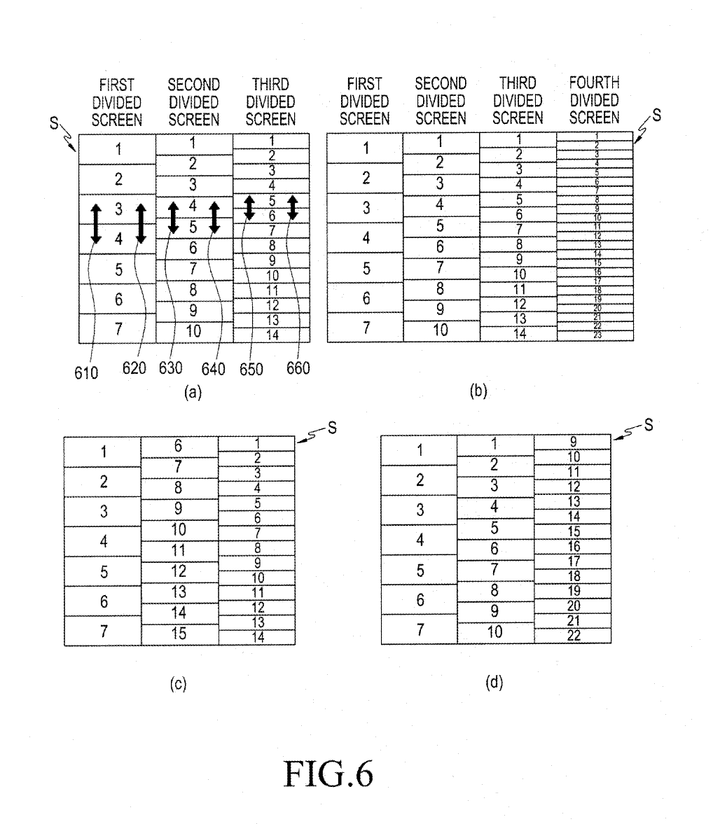

FIG. 3 is a flowchart showing a process for performing an easy scroll function according to an exemplary embodiment of the present invention. Also, FIG. 4, FIG. 5 and FIG. 6 are a first illustrative view, a second illustrative view and a third illustrative view, each showing a process for performing an easy scroll function according to an exemplary embodiment of the present invention. Referring collectively to FIGS. 3 through 6, in steps S301 and S302, when the display of items is requested, the controller 210 performs a control operation for displaying items in quantity matched with a display setting, on a display screen. For example, a user may request, via suitable input commands, the display of items within a set of 100 items, as illustrated by the list (a) of FIG. 4. In this case, the controller 210 performs a control operation for displaying items on one display screen of a touch screen S according to a display setting (for example, a setting for displaying 7 items), as shown in screen (b) of FIG. 4. Thus only a portion of the set of 100 items are displayed, because the set is large and the display setting is such that the items are displayed with text or image features large enough to be practically viewed by the user. The display setting may be set by default, by the user in a settings menu, or dynamically varied by preset commands.

In step S303, the controller 210 identifies whether a request for performing an easy scroll function (easy scroll display function) is made on the display screen. To illustrate one example of an easy scroll function request, screen (b) of FIG. 4 is shown with an imaginary dotted line down its center. Screen (b) may appear the same as a conventional display screen in which only a predetermined number (e.g. 7) of scrollable items of a set of a larger number (e.g. 100) of items is displayed According to an exemplary embodiment of the present invention, however, by discriminating between input areas of scroll inputs, the user may command conventional scrolling, or may command an easy scroll function.

According to an exemplary embodiment of the present invention, when a scroll input is entered in a preset area of the display screen, the controller 210 determines that an easy scroll function is requested. In contrast, when a scroll input is entered in an area other than the preset area, the controller 210 determines that the conventional scroll display is requested.

In the example presented, the easy scroll function corresponds to a left part of the display screen (i.e. a left display screen) and a right part of the display screen (i.e. a right display screen) corresponds to an area designated for a conventional scroll display request, when the display screen is virtually divided into the two equal left and right parts. (Note that different percentages of the screen may alternatively by designated for the respective conventional scroll and easy scroll function areas.)

Referring to screen (b) in FIG. 4, the user may enter a scroll input represented by vertical sweep path 410, or a scroll input 420 for items displayed according to the request for displaying items. According to discrimination between the scroll input 410 and the scroll input 420, the controller 210 determines whether the user makes a request for the conventional scroll display, or the easy scroll function, respectively.

In steps S304 and S305, when a conventional scroll request is sensed, the controller 210 performs a control operation for scrolling the items in response to the entered scroll input. For example, the 7 items initially displayed are changed to a different set of 7 items, out of the 100 items in the set. This is illustrated in screens (c) and (d) of FIG. 4, where screen (c) shows a first subsequent screen resulting from a scroll down input 410, and screen (d) shows a second subsequent screen resulting from another scroll down input 430 applied to screen (c).

On the other hand, when an input command for an easy scroll function detected at S303, e.g., by detecting a scroll down input 420 on screen (b), the process proceeds to steps S306 and S307. Here, the controller 210 performs a control operation to divide the display screen into a predetermined number N of parts (i.e., N divided display screens). Items are displayed on each of the divided display screens according to a respective display setting for each divided display screen. This is illustrated in the example of screen (a) of FIG. 5. In this example, N=two, such that first and second divided display screens are generated, divided between the left and right halves of the display area of screen S. Further, in the example, each divided display screen displays a different number of items in the set of 100 items.

Further, in the example, the first divided display screen displays the same number of items (7) as the previous (undivided, original) display screen. However, the number of items displayed on the second divided screen is greater than the number of items displayed on the first divided screen. If the predetermined number is three or more (or if a re-division occurs to generate 3 or more divided screens as described below), the number of items displayed on a third divided screen can be greater than the number of items displayed on the second divided screen. In general, the number of items displayed on the N^{th} divided screen is greater than the number of items displayed on an (N−1)^{th} divided screen. Namely, the greater the value of N becomes, the greater becomes the number of items displayed on a relevant divided display screen.

In an example as shown in (a) of FIG. 5, the first divided screen displays 7 items among a total of 100 items, and thus the first divided screen and the display screen before being divided into the divided screens are identical in the number of displayed items. Also, the second divided screen displays 10 items among a total of 100 items, and thus displays a higher number of items than the number of items displayed on the first divided screen. Note that in the example, the first and second divided screens display items beginning from the same item (item #1), and thus the two screens display common items. In alternative implementations, the second divided screen may begin at a different item number than the first divided screen. For example, the items of the second divided screen could alternatively begin at the first item number (item #8) subsequent to the last item number of the first divided screen. In another alternative, the second divided screen could be designed to initially display the last entries of the list, i.e., items 91 to 100 in the 100 item example.

The second divided screen displays a higher number of items than the number of items displayed on the first divided screen (or the display screen before being divided into the divided screens). Accordingly, an item intended to be selected (or executed) may be more rapidly identified in a case where items are scrolled by using the second divided screen as compared to the first divided screen. That is, a higher scroll rate is established by controller 210 for the Nth divided screen as compared to the first divided screen. For the same scroll input gesture (e.g., a vertical touch contact sweep motion on the touch screen by a distance D over an elapsed time T) a user can scroll through more items in the Nth part as compared to the first part.

As described above, in a case where the number of displayed items is different for each divided screen (for example, for each of the first divided screen and the second divided screen), when the user wants a speed of scrolling items to become slow (when the user desires accurate scroll display), the user may request scroll display through the first divided screen. Otherwise, when the user wants a speed of scrolling items to become fast, the user may request scroll display through the second divided screen. Namely, the user may freely select a speed of scroll display, depending on the user's circumstances.

Meanwhile, when the display screen is divided into an N number of divided screens, the number of items displayed on each divided screen is determined according to a display setting of each divided screen, and a display setting of each divided screen may be changed. For example, when the display screen is divided into 4 divided screens, a display setting may be established for each divided screen, e.g., by default or set by a user in a settings menu or the like. As shown in the example of FIG. 6, screen (b), a first divided screen is set to display 7 items, a second divided screen is set to display 10 items, a third divided screen is set to display 14 items, and a fourth divided screen is set to display 24 items.

In steps S308 to S310, when a result of the identification shows that a request for performing an easy scroll function is made on any one of the divided display screens, the controller 210 performs a control operation so as to re-divide the display screen into N+1 parts, i.e., one additional divided screen is generated. Items are then displayed in each re-divided screen according to a respective display setting of each divided screen.

Referring to screen (b) in FIG. 5, the user may enter any one of scroll inputs 510, 520, 530 and 540 on each of the first divided screen and the second divided screen.

An exemplary embodiment of the present invention for discriminating between an easy scroll function and a scroll display request according to the type (e.g. input position) of a scroll input entered on the display screen in steps S303 and S304, is also applied to each of the divided display screens.

For instance, the user may determine that the number of items displayed on the second divided screen, on which 10 items are displayed, is insufficient for rapidly scrolling a large list, whereby, the user may command additional screen division. In other words, when the user desires to scroll items at a faster rate than that afforded by the second divided screen, on which the 10 items are displayed, the user may request an additional division of the display screen to additionally generate at least a third divided screen. In contrast, when the user determines that the number of items displayed on the second divided screen is appropriate, the user may request scroll display on any one of the first divided screen and the second divided screen.

For example, by entering a scroll input 510 or a scroll input 530 in an area corresponding to a left part of each divided screen, the user may request the re-division of the display screen divided into the first and second divided screens. In contrast, by entering a scroll input 520 or a scroll input 540 in an area corresponding to a right part of each divided screen, the user may request the scrolling of items on the first divided screen or on the second divided screen.

When the user enters the scroll input 510 or the scroll input 530 among the scroll inputs 510, 520, 530 and 540 as shown in (b) of FIG. 5, the controller 210 performs a control operation for re-dividing the display screen into N+1 parts, e.g., three divided screens as compared to two divided screens, in the case of the predetermined number N=2. This is illustrated in FIG. 6, screen (a).

Similarly to the above description, by entering any one of scroll inputs 610, 630 and 650, the user may once again request the division of the display screen. In response to this request, the controller 210 may cause the display screen, which is currently divided into 3 divided screens, to be displayed in such a manner as to be once again divided into 4 divided screens, as shown in screen (b) of FIG. 6.

In steps S311 and S312, when a result of the identification shows that scrolling on any one of the divided display screens is requested, the controller 210 performs a control operation for scrolling items in response to this request.

As described in the previous steps, by entering the scroll input 520 or the scroll input 540 in the area corresponding to the right part of each of the divided screens as shown in (b) of FIG. 5, the user may request the scroll display of items on any one of the first divided screen and the second divided screen.

For example, when the user enters the scroll input 520 (for example, a scroll down input), the controller 210 performs a control operation for scrolling items displayed on the first divided screen as shown in (c) of FIG. 5, in response to the entered scroll input 520. In another example, when the user enters the scroll input 540 (for example, a scroll down input), the controller 210 performs a control operation for scroll-displaying items displayed on the second divided screen as shown in (d) of FIG. 5, in response to the entered scroll input 540. Thus the divided screens are independently scrollable.

The scrolling of any one of the divided display screens as described above in steps S311 and S312 may be identically applied to each of the re-divided display screens as shown in (b) of FIG. 6.

For example, when the user enters the scroll input 640 on the display screen which is re-divided into three parts as shown in (a) of FIG. 6, the controller 210 performs a control operation for scrolling items on a second divided screen as shown in (c) of FIG. 6. Otherwise, when the user enters a scroll input 660 on the above display screen, the controller 210 performs a control operation for scroll-displaying items on a third divided screen as shown in (d) of FIG. 6.

When the number of items to be displayed is large, through the scroll display process (easy scroll function) of the present invention as described hereinabove, the user may request the division of a display screen, and may make a request for rapidly scrolling items on a relevant divided screen among the divided display screens.

When an item desired by the user is identified (displayed) through the rapid scroll display of items, the user may select (or execute) the desired item. Accordingly, the user may rapidly select or execute an item according to an exemplary embodiment of the present invention.

According to exemplary embodiments of the present invention as described above, an advantage is provided in that the user can easily select a conventional scroll display function or an easy scroll function as described herein, according to the user's need, even without a separate setting.

Also, according to an exemplary embodiment of the present invention as described above, the present invention provides an advantage in that the user may easily adjust a speed of scrolling items according to the user's need, via simple touch gesture on the display screen, while the display screen is already divided into parts following an initial easy scroll function operation.

Embodiments advantageously enable the user to easily select via touch gesture whether a conventional scroll function or an easy scroll function should be operated, according to the need of the user, even without a separate setting.

Moreover, embodiments have an effect in that the user may easily adjust a speed of scroll-displaying items according to the need of the user on the display screen divided into parts when the easy scroll function is used.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it will be apparent that the above-described exemplary embodiments are only for illustrative purposes and are not meant to be a limitation of the present invention. Therefore, a change of elements, such that an element may be equally replaced by another element in an embodiment of the present invention without departing from the technical idea or field of the present invention as defined by the appended claims, will fall within the scope of the present invention.

What is claimed is:

1. A method for scrolling items on a display screen in an electronic device, the method comprising:
displaying on the display screen a first number of scrollable items representing a portion of a set of displayable items;
detecting an input command for performing an easy scroll function on the display screen; and
responsive to the detected input command, dividing the display screen into a predetermined number of divided display screens, each independently scrollable and each displaying a respective number of items of the set of items, according to a display setting therefor.

2. The method as claimed in claim 1, wherein the input command is a scroll input on a preset area of the display screen on which the items are displayed.

3. The method as claimed in claim 2, wherein the preset area corresponds to a left side of the display screen when items are scrollable vertically on the display screen.

4. The method as claimed in claim 3, further comprising, prior to detecting the input command, scrolling the items on the display screen in response to an entered scroll input, when the scroll input is entered on a right side of the display screen.

5. The method as claimed in claim 1, wherein the divided display screens comprise a first divided display screen in which the same first number of items are displayed, and at least one second divided display screen in which a higher number of items are displayed.

6. The method as claimed in claim 5, wherein a scroll input gesture applied to the second divided display screen results in a higher rate of scroll than the same scroll input gesture applied to the first divided display screen.

7. The method as claimed in claim 1, wherein first and second divided display screens of the predetermined number of divided display screens each display at least one common item when the divided display screens are generated.

8. The method as claimed in claim 1, wherein the predetermined number of divided display screens is an integer N of at least two, and further comprising re-dividing the display screen into N+1 divided display screens, when a request for performing the easy scroll function is made on any one of the N divided display screens.

9. The method as claimed in claim 8, wherein the input command for performing an easy scroll function on the display screen is a scroll input on a preset area of the display screen on which the items are displayed, and the request for performing the easy scroll function made on any one of the N divided display screens is a scroll input entered in a preset area of that divided display screen.

10. The method as claimed in claim 9, wherein the preset area of the divided display screen is an area corresponding to a left part thereof when the items are scrollable vertically.

11. A non-transitory recording medium storing computer-executable instructions for performing the method of claim 1.

12. An apparatus for displaying and scrolling items, the apparatus comprising:
a display unit controllable to display on a display screen a first number of scrollable items representing a portion of a set of displayable items; and
a controller coupled to the display unit and configured to detect an input command for performing an easy scroll function on the display screen, and responsive to the detected input command, to control dividing of the display screen into a predetermined number of divided display screens, each independently scrollable and each displaying a respective number of items of the set of items, according to a display setting therefor.

13. The apparatus as claimed in claim 12, wherein the input command for performing an easy scroll function is a scroll input in a preset area of the display screen, on which the items are displayed.

14. The apparatus as claimed in claim 13, wherein the preset area corresponds to a left side of the display screen when items are scrollable vertically on the display screen.

15. The apparatus as claimed in claim 14, wherein the controller performs a control operation, prior to detecting the input command, to scroll the items on the display screen in response to a scroll input entered on a right side of the display screen.

16. The apparatus as claimed in claim 12, wherein the divided display screens comprise a first divided display screen in which the same first number of items are displayed, and at least one second divided display screen in which a higher number of items are displayed.

17. The apparatus as claimed in claim 12, wherein the predetermined number of divided display screens is an integer N of at least two, and the controller performs a control operation to re-divide the display screen into N+1 divided display screens, when a request for performing the easy scroll function is made on any one of the N divided display screens.

18. The apparatus as claimed in claim 17, wherein the input command for performing an easy scroll function on the display screen is a scroll input on a preset area of the display screen on which the items are displayed, and the request for performing the easy scroll function made on any one of the N divided display screens is a scroll input entered in a preset area of that divided display screen.

19. The apparatus as claimed in claim 20, wherein the preset area of the divided display screen is an area corresponding to a left side thereof when the items are scrollable vertically.

20. A portable electronic device comprising:
a touch screen display unit controlled to display on a display screen a first number of scrollable items representing a portion of a set of displayable items; and
a controller coupled to the display unit and configured to detect an input command for performing an easy scroll function, and responsive to the detected input command, to control dividing of the display screen into a predetermined number of divided display screens, each independently scrollable and each displaying a respective number of items of the set of items, according to a display setting therefor.
